(19) United States
(12) Patent Application Publication
(10) Pub. No.: US 2007/0058641 A1
(43) Pub. Date: Mar. 15, 2007

(54) Enterprise physical layer switch

(76) Inventors: Christopher J. Cicchetti, Menlo Park, CA (US); Richard Jew, San Francisco, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/397,021

(22) Filed: Apr. 3, 2006

Related U.S. Application Data
(60) Provisional application No. 60/667,635, filed on Apr. 1, 2005.

(51) Int. Cl. H04L 12/56

(52) U.S. Cl. 370/400

(57) ABSTRACT

A physical layer switch is provided that includes a switch cross bar for changeably interconnecting selected ports within a physical layer switch such that an optical signal can be changeably routed between selected ports, a first port in communication with the switch cross bar, and a second port in communication with the first port, wherein a signal entering the physical layer switch at the first port is routed to the switch cross bar and a mirror copy of the signal entering the physical layer switch at the first port is routed to the second port such that it does not reach the switch cross bar.

### CROSS-REFERENCE TO RELATED APPLICATIONS

This application claims the benefit of U.S. Provisional Patent Application No. 60/667,635, filed Apr. 1, 2005, which is incorporated herein by reference in its entirety.

### BACKGROUND OF THE INVENTION

1. Field of the Invention

The present invention relates generally to the field of network monitoring analysis.

2. The Relevant Technology

In an age when television commercials show everyday people effortlessly accessing their bank account's information from a street corner by way of a cell phone, its is ironic that accessing data flowing within its physical source—the network—is, without advanced preparation, nearly impossible. In fact, for many IT organizations the network itself has become an impenetrable black box. In the rush to boost network speeds, most companies have migrated from token ring or other peer-to-peer topologies to switched networks such as Local Area Networks (LANs) and Storage Area Networks (SANs). While the new technology has yielded the desired result, increased speed, it has made access to the data flowing through connections within the network more difficult. Unlike peer-to-peer networks with their centralized data flows, where access is a matter of acquiring data as a peer node, switched networks have a decentralized structure with no ready access points. Accordingly, when network problems or slowdowns occur, or when monitoring becomes desirable, administrators often do not have the necessary access to network data flows to diagnose their problems or to monitor.

### BRIEF SUMMARY OF THE INVENTION

A physical layer switch is discussed herein that provides access to network traffic information while reducing or minimizing the introduction of a potential location of failure. Accordingly, a first example embodiment of the invention is a physical layer switch that includes a switch cross bar for changeably interconnecting selected ports within a physical layer switch such that an optical signal can be changeably routed between selected ports; a first port in communication with the switch cross bar; and a second port in communication with the first port, wherein a signal entering the physical layer switch at the first port is routed to the switch cross bar and a mirror copy of the signal entering the physical layer switch at the first port is routed to the second port such that it does not reach the switch cross bar.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings which:

FIG. 1 illustrates a generalized schematic view of a simplified network according to one example.

FIG. 2 illustrates a schematic view of a physical layer switch according to one example.

FIG. 3 illustrates a schematic view of a physical layer switch that includes a passive optical traffic access port according to one example.

FIG. 4 illustrates a schematic view of a physical layer switch that includes an active optical traffic access port according to one example.

FIG. 5 illustrates a schematic view of a physical layer switch that includes an active copper traffic access port according to one example.

### DETAILED DESCRIPTION OF THE PREFERRED EMBODIMENTS

A physical layer switch (PLS) is provided herein for use in networks. The PLS includes at least one traffic access port (TAP) coupled to at least one switch cross bar. Each TAP provides inline access to one or more links between network devices. TAPs generally include network ports and at least one monitor port. TAPs allow network traffic to flow uninterrupted between the network ports while providing a mirror copy of the network traffic to the monitor port. A switch cross bar is connected to one or more TAPs. The switch cross bar may include one or more ports for connecting monitoring device or analyzer thereto. Such a configuration provides a centralized and readily reconfigurable troubleshooting location where information collected from TAPs can be routed to almost any variety of test equipment. Once the PLS is deployed, administrators can test any point within their networks without changing the physical setup or stopping the network. Further, many troubleshooting software packages and the PLSs may be remotely controllable, thereby allowing for remote debugging.

Reference will now be made to the figures wherein like structures will be provided with like reference designations. It is understood that the drawings are diagrammatic and schematic representations of presently preferred embodiments of the invention, and are not limiting of the present invention nor are they necessarily drawn to scale.

In the following description, numerous specific details are set forth in order to provide a thorough understanding of the present invention. It will be obvious, however, to one skilled in the art that the present invention may be practiced without these specific details. In other instances, well-known aspects of traffic access ports, physical layer switches, and networks have not been described in particular detail in order to avoid unnecessarily obscuring the present invention.

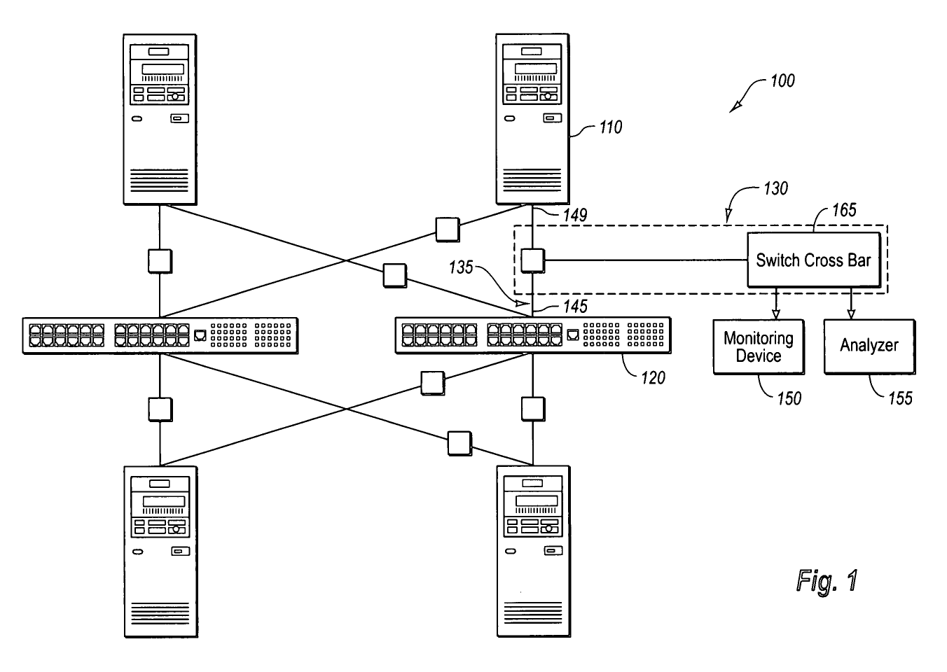

FIG. 1 illustrates a generalized schematic view of a simplified network (100) according to one example, such as a storage area network (SAN). The network generally includes a plurality of network devices, such as a first network device (110) and a second network device (120). The network (100) also includes a physical layer switch (PLS) (130). A network link (135) couples the first network device (110) to the second network device (120). In particular, a first segment (140) connects the first network device (110) to the PLS (130) and a second segment (145) connects the PLS (130) to the second network device (120). While two network devices (110, 120) are shown and discussed, those of skill of art will appreciate that any number of network devices-may be linked, as shown in FIG. 1.

The PLS (130) is configured to allow transfer of information between the first and second network devices (110, 120) while providing monitoring capabilities. In particular, the TAP (160) allows the information to flow freely between the first network device (110) and the second network device (120) while providing access for a monitoring device (150) and/or an analyzer (155) to the network link (135). More specifically, the TAP (160) transfers data between the network devices (110, 120) along the link (135). Additionally, the TAP (160) mirrors the data transferred along the network link (135). This mirrored data is made available for use by other devices. For example, according to the illustrated example, the TAP (160) provides the mirrored data to a switch cross bar (165). The TAP (160) is located in-line, such that the mirrored data directed to the switch cross bar (165) provides a view of the traffic within the network link (135) between the first and second network devices (110, 120). The TAP (160) may be of any suitable type, including, without limitation, an active or passive optical TAP, an active copper TAP, a switching TAP, and/or an aggregator TAP.

While a single TAP (160) is described as transferring data to the switch cross bar (165), FIG. 1 makes clear that data from any number of TAPs (160) may be directed to the switch cross bar (165). Any number of devices, such as the monitoring device (150) and/or the analyzer (155) may then be selectively coupled to the PLS (130). The internal operation of the PLS (130), including the tap (160), will now be discussed in more detail.

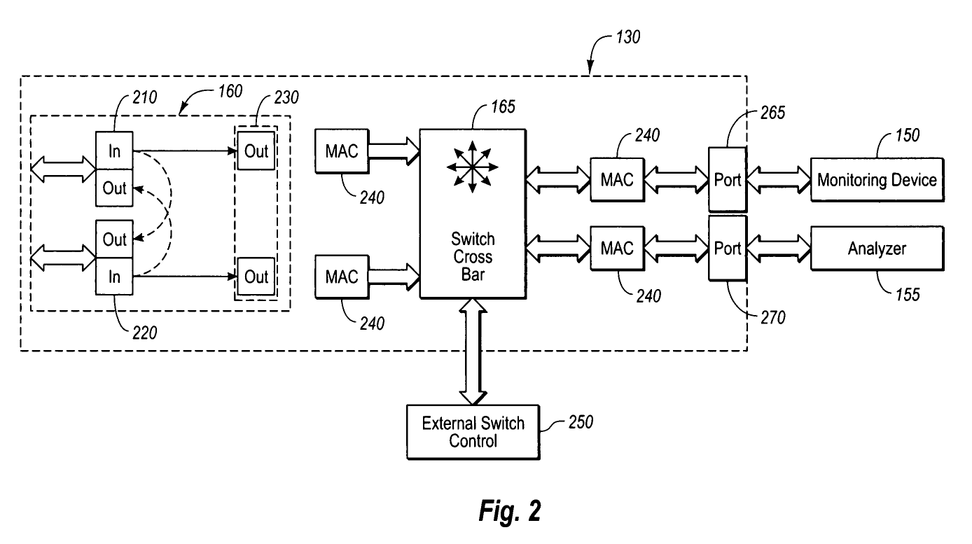

FIG. 2 illustrates a more detailed schematic view of the function of the PLS (130), and of the TAP (160) in particular. As previously discussed, the PLS (130) includes at least one traffic access port (TAP) (160) and at least one switch cross bar (165). Such a configuration may allow administrators to harness the connectivity characteristics of conventional PLSs, and maintain their cost-effectiveness, while reducing or minimizing the introduction of prospective points of failure into their networks. As previously introduced, TAPs are devices that provide a physical access point within a network. FIG. 2 illustrates how the TAP (160) provides one or more outputs that mirror the data passing through the device. More specifically, the TAP (160) according to the present example is a multi-port device, such as a three-port device that contains network ports (210, 220). The network ports (210, 220) pass traffic between the two devices connected to them. The TAP (160) also includes a monitor port (230) that provides a copy of the data flowing in either direction.

The monitor port (230) does not have the ability to modify or degrade the data passing through the device. In addition, the TAP (160) will continue to pass data between the network ports (210, 220) without disruption if the power to the TAP (160), where used, is interrupted. The same is true of the entire PLS (130). More specifically, the TAP (160) will continue to transfer data between the first and second network ports (210, 220), if other components coupled to the monitor port (230), such as the switch cross bar (165), lose power or otherwise fail. Thus, the TAP (160) provides access to network traffic, does not create a location to modify or corrupt data, and does not represent a prospective point of failure.

As introduced, the TAP (160) includes a monitor port (230). According to the present example, the monitor port (230) is coupled to the switch cross bar (165), which in turn has a monitoring device (150) and/or analyzer (155) coupled thereto. Such a configuration may provide low-latency, non-blocking, “any-to-any” switching for equipment to access the network. For example, data routed from the TAP (160) is passed through a media access control address (MAC) (240) to the switch cross bar (165). The switch cross bar (165) according to the present exemplary embodiment may be coupled to an external switch control (250). According to the present example, the switch control (250) may include a Local Area Network.

The external switch control (250) controls the transfer of data through the switch cross bar (165) by switching the traffic passing therethrough. In particular, the external switch control (250) controls how the switch cross bar (165) routes data from the TAP (160) to other devices. For example, the switch cross bar (165) may be coupled to a plurality of outlet ports (265, 270) by way of additional MACs (240). Various devices, such as the monitoring device (150) and/or the analyzer (155) may be connected to the outlet ports (265, 270). The switch cross bar (165) receives instruction from the switch control (250) to determine how data from the TAP (160) is transferred to the outlet port (265, 270) and thus to the monitoring device (150) and/or the analyzer (155).

The monitoring device (150) and/or the analyzer (155) may be part of a testing system. Each of these devices and their function will now be discussed in more detail. The monitoring device (150) may provide information related to the location of network traffic jams and the cause or source of the traffic jams. In particular, the monitoring device (150) may receive data related to each link between devices in a network from a TAP (160) associated with that link. This data, when accumulated and plotted over time, provides insight for activities such as capacity planning. Capacity planning in a network may be aided by knowing information about the characteristics of traffic flow, such as location, time, and volume of traffic flow over each link, and by extension across the network.

When a network device begins to fail, data corruption frequently provides an indication of the device's decline. The monitoring device (150) can detect network errors and warn administrators that future danger may be lurking. The PLS (130) not only provides the necessary access points for the monitoring device (150), the PLS (130) also provides a view that may be important for device failure detection not available from other network components. This information may be referred to as Link Layer access. Conventional network equipment frequently strips away Link Layer information. The Link Layer information often contains error information. Thus, by stripping away Link Layer information, conventional network equipment frequently strips away error information. The inline TAP (160) associated with the PLS (130) presents all the information flowing between network components, from the Physical to the Application Layer, including the Link Layer information. Thus, the PLS (130) may provide access to error information that may be used in monitoring the performance of a network.

In addition, the PLS (130) may provide the analyzer (155) with direct access to network traffic. For example, when networks have problems, the affected organizations usually develop a singular focus. The focus usually begins by troubleshooting the network. Troubleshooting begins by identifying the affected subsystem, and then usually proceeds to connecting an analyzer into the data path between suspect network devices to collect copies of the conversations going on between the equipment. The conversations, also known as traces, allow technicians, or expert software, to analyze the commands flowing between the equipment. Analysis usually provides the answer, or at least a clue, as to the network's problems, allowing a quick diagnosis and a start to remedying the network's problem.

As previously introduced, the TAP (160) is installed inline within one or more of the network links, such that each network link may have a TAP (160) associated therewith. As a result, analysis of such a network may be readily accomplished. In particular, the analyzer (155) may be connected inline into any link via the TAP (160) associated with that link. If one location does not provide answers, the analyzer (155) can be quickly coupled to any other TAP (160) by way of the switch cross bar (165) without interrupting network traffic flow. Although the PLS (130) may include one or more TAPs, it is also contemplated that stand alone TAPs can be physically connected to a switch cross bar or in communication with and adjacent to a switch cross bar in a modular removably connected fashion.

In addition to providing monitoring and analysis information, the PLS (130) may be used for intrusion detection/prevention. With the increased focus on corporate network security, many companies have begun to install Intrusion Detection Systems (IDS) into their networks to determine if and when hackers attempt to attack or infiltrate them. These systems detect intrusion by monitoring traffic flows where the network connects to the Internet. This location is sometimes called the network “edge”. Often, the intrusion detection systems look for data coming from certain locations, e.g. data with a known IP address, as a clue that someone is attempting to hack the network. Masses of similar data from multiple locations can inform the system that it is under a denial-of-service attack. Another technique is to look for known data patterns, or “signatures”, that herald an unwelcome visitor. Intrusion Prevention Systems (IPS) is a recent technology that builds another capability on top of IDS, the ability to stop intruders. IPS operates by utilizing IDS to detect undesirable traffic and then adds another system to reroute, or simply remove, the undesirable traffic. The TAP (160) may provide the data visibility on the network edge required to detect external threats.

To this point, the TAP (160) has been described generally with respect to the PLS (130). Several TAPs will now be described in more detail. TAPs may generally be described as active or passive. Active TAPs include, without limitation, active optical TAPs and active copper TAPs. Passive TAPs include, without limitation, passive optical TAPs. An active TAP is one that uses electricity, while a passive. TAP does not. The term “optical” is shorthand for “optical fiber”, the conductor in optical networks. Fiber optic networks use optical fibers to shuttle photons (light) from device to device. The following subsections provide an overview of the variety of TAPs available within each of the TAP groupings.

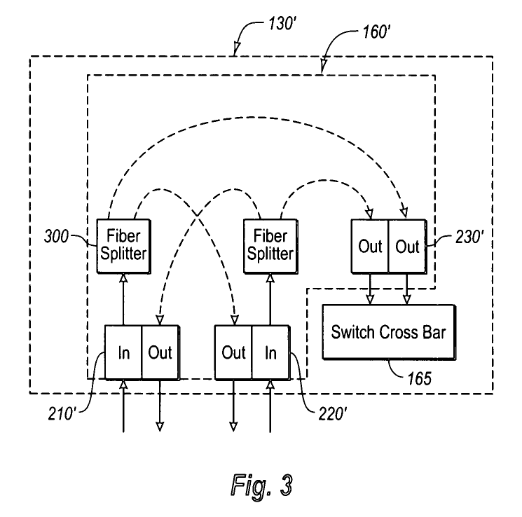

FIG. 3 illustrates a schematic view of PLS (130′) that includes a passive optical TAP (160′). As the name suggests, passive optical TAPs have no power. Therefore, light signals passing through the passive optical TAP (160′) are unaffected regardless of what happens to the power for the rest of the data center. In particular, the optical TAP (160′) makes use of light as the signal carrier. Light travels in only one direction. This property allows passive optical TAPs to provide monitoring data by splitting the input signal's light energy. The path the light travels through the optical TAP (160′) is shown with dashed and dotted lines.

Light entering the passive optical TAP (160′) enters the IN portion of network ports (210′, 220′). For example, light entering the first network port (210′) is split by a fiber splitter (300). A portion of the light to be transmitted out of the passive optical TAP (160′), which is represented by the dotted lines, is routed to the OUT portion of the other network port (220′). The portion of the light to be monitored is represented by the dashed lines. The light to be monitored is routed to the OUT portion of a monitor port (230′) and to the switch cross bar (165; FIG. 2). The same splitting and routing occurs with respect to light entering the IN portion of the second network port (220′). The light routed to the OUT portion of the monitor (230′) is then selectively directed out to other devices by way of a switch cross bar (165; FIG. 2). Such a configuration provides a monitoring point while minimizing the possibility that the original signal might be corrupted.

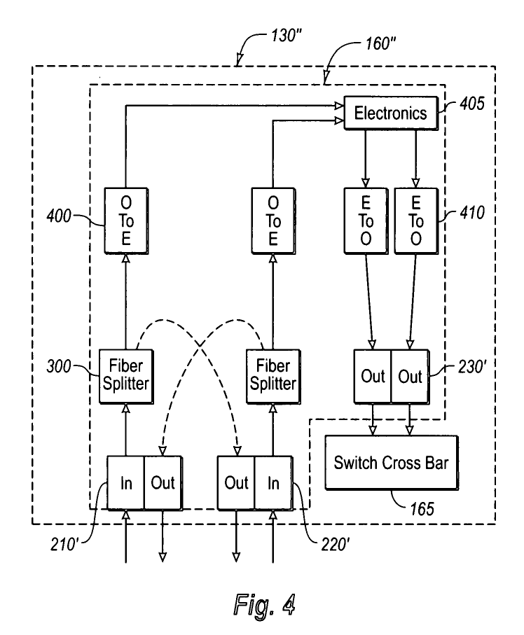

FIG. 4 illustrates a schematic view of a PLS (130″) that includes active optical TAP (160″). The active optical TAP (160″) is substantially similar to the passive optical TAP (160′; FIG. 3) with respect to the network port connections. Accordingly, light enters the network ports (210′, 220′) and a portion of the light is transmitted through the device to other network ports. In the active optical TAP (160″), the portion of the light to be monitored passes through an optical to electrical converter (400) which converts the optical signal to electronic signals. The electronic signals are then passed to electronics (405). As the signal is passed through the electronics (405), the signal may be amplified or otherwise conditioned for use by other devices. The electronic signals are then passed through an electronic to optical converter (410), which converts the electrical signals to optical signals. The optical signals are then transmitted through the monitor port (230′) and on to a switch cross bar (165), which selectively directs the light to other devices.

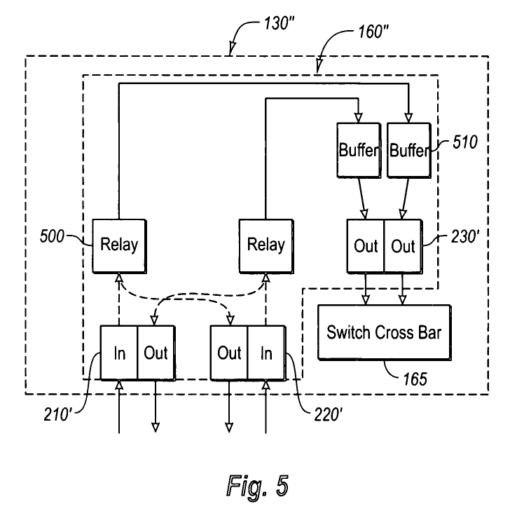

FIG. 5 illustrates a schematic of a PLS (130′″) that includes an active copper TAP (160′″); Dotted and dashed lines represented the flow of data through the active copper TAP (160′″). More specifically, a signal entering the IN portion of a first network port (210″) is split. A portion of the signal is transmitted to the OUT portion of the second network port (220″) while another portion of the signal is transmitted to a relay (500). The relay (500) according to present example is a two position type relay. When the active copper TAP (160′″) is powered, the relay (500) is closed, such that the signal to be monitored passes through the relay (500) and on to a buffer (510). The buffer (510) allows the signal to pass to the monitor port (230″), but reduces or minimizes the possibility that a signal will be passed from the monitor port (230″) back to the network ports (210″, 220″). In a similar manner, while the active copper TAP (160′″) is powered, a portion of a signal entering the IN portion of the second network port (220″) is split and routed through the OUT portion of the first network port (210″) while another portion of the signal is routed to through the relay (500) and buffer (510) to the monitor port (230″).

When power is cut to the active copper TAP (160′″), the relays (500) are opened, thereby isolating the network ports (210″, 220″) from the rest of the circuitry within the TAP (160′″). As a result, a loss of power does not affect the flow of-data between the network ports (210″, 220″). In particular, with the relays (500) opened, the network ports (210″, 220″) are isolated from the buffers (510). As a result, charge in the buffers (510) is prevented from flowing back into the TAP (160′″) to the network ports (210″, 220″) when power is lost.

To this point, PLSs have been described that include one TAP per link. Further, PLSs have been described that include TAPs that provide full-time access to network traffic while provide no interruptions to that network traffic. Those of skill in the art will appreciate that other configurations are possible. For example, zero-delay and low-latency active copper TAPs may also be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A physical layer switch, comprising:
a switch cross bar for changeably interconnecting selected ports within a physical layer switch such that an optical signal can be changeably routed between selected ports;
a first port in communication with the switch cross bar; and
a second port in communication with the first port, wherein a signal entering the physical layer switch at the first port is routed to the switch cross bar and a mirror copy of the signal entering the physical layer switch at the first port is routed to the second port such that it does not reach the switch cross bar.

2. The physical layer switch of claim 1, wherein the first port and the second port comprise a traffic access port (TAP).

3. The physical layer switch of claim 2, wherein the traffic access port comprises an active traffic access port.

4. The physical layer switch of claim 3, wherein the active traffic access port comprises an active optical traffic access port.

5. The physical layer switch of claim 3, wherein the active traffic access port comprises an active copper traffic access port.

6. The physical layer switch of claim 2, wherein the traffic access port comprises a switching traffic access port.

7. The physical layer switch of claim 1, wherein the switch cross bar is coupled to external switching control.

8. The physical layer switch of claim 2, wherein the traffic access port comprises a passive optical traffic access port.

9. The physical layer switch of claim 1, wherein the first portion of the optical signal is routed by the switch cross bar to a third port.

10. The physical layer switch of claim 1, wherein an optical signal entering the physical layer switch at the second port is routed to the switch cross bar and a mirror copy of the optical signal entering the physical layer switch at the second port is routed to the first port such that it does not reach the switch cross bar.

11. A physical layer switch, comprising:
at least one traffic access port configured to be located in at least one network link, said traffic access port including first and second network ports and at least one monitor port; and
a switch; cross bar coupled to said monitor port wherein a signal entering the physical layer switch at the first network port is routed to the switch cross bar and a mirror copy of the signal entering the physical layer switch at the first network port is routed to the second network port such that it does not reach the switch cross bar.

12. The physical layer switch of claim 11, wherein said traffic access port comprises an optical traffic access port.

13. The physical layer switch of claim 12, wherein said optical traffic access port comprise at least one of an active optical traffic access port or a passive optical traffic access port.

14. The physical layer switch of claim 11, wherein said traffic access port comprises an active copper traffic access port.

15. The physical layer switch of claim 11, wherein said traffic access port comprises a switching traffic access port.

16. The physical layer switch of claim 11, wherein said traffic access port comprises an aggregator traffic access port.

17. The physical layer switch of claim 11, further comprising a plurality of traffic access ports coupled to said switch cross bar.

18. A network monitoring system, comprising:
a physical layer switch including at least one traffic access port configured to be located in at least one network link, said traffic access port including first and second network ports and at least one monitor port, and a switch cross bar coupled to said monitor port wherein a signal entering the physical layer switch at the first network port is routed to the switch cross bar and a mirror copy of the signal entering the physical layer switch at the first network port is routed to the second network port such that it does not reach the switch cross bar;
at least one port coupled to said switch cross bar; and
at least one of a monitoring device and an analyzer selectively coupled to said port.

19. The network monitoring system of claim 18, wherein said traffic access port comprises an optical traffic access port.

20. The network monitoring system of claim 18, and further comprising a plurality of traffic access ports.
